(19) United States
(12) Patent Application Publication
(10) Pub. No.: US 2023/0131265 A1
(43) Pub. Date: Apr. 27, 2023

(54) PROCESS FOR THERMALLY TREATING A BATTERY MATERIAL IN A THERMAL REACTOR

(71) Applicant: IBU-TEC ADVANCED MATERIALS AG, Weimar (DE)

(72) Inventors: Toralf RENSCH, Weimar (DE); Matthias OMMER, Jena (DE); Christian KLAUS, Jena (DE); Ulrich WEITZ, Weimar (DE); Karl WEGNER, Erfurt (DE)

(21) Appl. No.: 17/905,502

(22) PCT Filed: Mar. 2, 2021
(86) PCT No.: PCT/EP2021/055177

§ 371 Date: Sep. 1, 2022

(30) Foreign Application Priority Data
Mar. 2, 2020 (DE) 10 2020 202 658.0

(51) Int. Cl. H01M 4/04

(52) U.S. Cl. CPC H01M 4/0471; H01M 2004/021

(57) ABSTRACT

The invention relates to a process for thermally treating, in particular synthesizing and/or drying and calcinating, a nano- and/or micro-scale or nano- and/or micro-crystalline battery material (BM) and/or battery material precursor (BM) in a thermal reactor (1), comprising the steps of: introducing a starting compound (AV) into the reactor (1), the starting material (AV) being a battery material (BM) and/or battery material precursor (BM) and the starting material (AV) being introduced into the reactor (1) in the form of a solution, slurry, suspension or in a solid state of matter, thermally treating the battery material (BM) and/or battery material precursor (BM) carried in a hot gas flow (HGS) in a treatment zone in the reactor (1) at a temperature of 150° C. to 1000° C., and discharging the battery material (BM) obtained from the reactor (1) in the form of a powder.

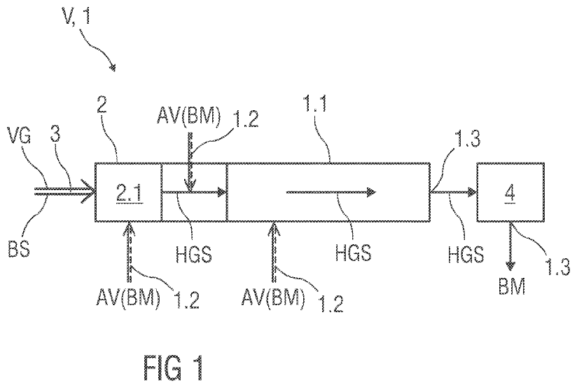

The invention relates to a method for the thermal treatment of a nano- and/or micro-scale or nano- and/or micro-crystalline battery material.

Devices for the thermal treatment of a raw material are, for example, pulsation reactors, as described in WO 02/072471 A1 or DE 10 2004 044 266 A1 and WO 2019/197147 A1.

Pulsation reactors are used, for example, for thermal synthesis of a raw material for the production of fine-grain particles, in particular fine-grain materials.

The object of the invention to specify a particularly environmentally friendly method for the thermal treatment of a nano- and/or micro-scale or nano- and/or micro-crystalline battery material.

According to the invention the object is achieved by the features of claim 1.

Advantageous configurations of the invention are the subject matter of the dependent claims.

According to the invention, the object is achieved by a method for thermal treatment, in particular by synthesis and/or drying and calcination, of a nano- and/or micro-scale or nano- and/or micro-crystalline battery material in a reaction space of a thermal reactor, comprising the steps:
Introduction of a starting compound into the reaction space, with a battery material and/or a battery precursor material, in particular a sodium- or lithium-containing battery material and/or battery precursor material, being introduced as the starting compound, and with the starting compound in the form of a solution, slurry, suspension or in a solid state of aggregation is introduced into the reaction space,
thermal treatment of the battery material and/or battery precursor material carried in a hot gas stream (HGS) in a treatment zone in the reaction space at a temperature of 150° C. to 1000° C., and
Extraction of the obtained battery material in powder form from the reactor.

A further aspect provides a method for the thermal treatment, in particular by synthesis and/or drying and calcination, of a nano- and/or micro-scale or nano- and/or micro-crystalline battery material and/or battery precursor material in a thermal reactor with an application space and a reaction space, which includes the following steps:
Introduction of a starting compound seen in the direction of flow of a hot gas stream in the thermal reactor at a front feed point in the thermal reactor, with a battery material and/or a battery precursor material being introduced into the reactor as a starting compound in the form of a solution, slurry, suspension or in a solid state of aggregation,
Thermal treatment of the battery material and/or battery precursor material carried in the hot gas stream in a treatment zone in the thermal reactor at a temperature of 150° C. to 1,000° C. with a residence time of 0.1 s to 2 s, with a reaction of the starting compound to the battery material by synthesis and/or drying and calcination occurring in a single step in the hot gas stream in the thermal reactor,
Extraction of the obtained battery material in powder form from the reactor.

The thermal treatment is in particular a method in which the battery material and/or the battery precursor material is/are synthesized, dried and/or calcined by means of the hot gas stream. A sufficiently high energy input takes place within a short residence time of less than 2 s due to the finely distributed direct treatment in the hot gas stream. Sintering can be prevented by reducing the amount of liquid in the battery material and/or battery precursor material within the short residence time and at corresponding temperatures, in particular in the low range.

Drying and calcining is understood to mean in particular caking and calcining the liquid substance, in particular the solution, slurry, suspension, or a solid but moist starting material. The thermal treatment takes place in a flowing hot gas, which causes the starting compound, in particular a battery precursor material, to be converted into the battery material by synthesis and/or drying and calcination. Surprisingly, it was found that due to the short residence time and thus short reaction time as a result of the conversion achieved by synthesis and/or achieved by drying and calcining in the thermal reactor in a single step, very finely divided particles with the correct stoichiometry for the battery material obtained in powder form can be achieved.

A single step is understood in particular as the continuous thermal treatment of the starting compound and its conversion to the battery material in the hot gas stream of the thermal reactor, namely from the introduction of the starting compound, in particular by extremely fine distribution, into the hot gas stream of the thermal reactor and thermal treatment of this starting compound by synthesis and/or drying and calcining in the hot gas stream with short residence times of 0.1 s to 2 s in combination with low to high temperatures of 150° C. to 1,000° C. until the dried and calcined battery material is removed from the thermal reactor.

In a first possible exemplary embodiment, a starting compound introduced as a battery precursor material can be converted into the battery material by synthesis and drying and calcining in a single step in the hot gas stream in the thermal reactor. In a second exemplary embodiment, in the case of a starting compound introduced as moist battery material, the starting compound is converted into the battery material only by drying and calcining in a single step in the hot gas stream in the thermal reactor.

The method according to the invention differs significantly from the method known in the art in terms of the energy transfer and the course of the reaction through synthesis and/or drying and calcination through extremely fine distribution of the starting compound in the hot gas and its thermal treatment in the hot gas stream with a very short residence time of approx. 0.1 s to 2 s, which surprisingly allows for producing very fine-grain particles.

The advantages achieved with the invention are, in particular, that, in comparison to conventional methods, the battery material is cleaned and/or thermally treated, in particular dried and calcined, in an environmentally friendly manner quickly, easily and in only one step. In addition, a higher yield and special properties (such as setting the crystallite size, in particular homogeneous particle and/or crystallite size distribution, crystal damage recovery) are achieved for the thermally treated battery material. In this case, an escape of substance into an environment is preferably avoided. Elaborate pre-drying, intermediate steps, purification, and thermal pre- and/or post-treatments, such as lengthy calcinations, are avoided.

In one possible embodiment, a combustion gas and a fuel are fed into the reactor, in particular into the application space, and ignited there. As a result, a hot gas stream is generated, in which the starting compound, seen in the flow direction of the hot gas stream in the reactor, is fed into the reactor at a front feed point, for example into the application space and/or into the reaction space in the area on the flow inlet side, and is carried and transported by the hot gas stream. The hot gas stream is formed by the hot gases produced during combustion. The combustion of fuel and combustion gases can take place without a flame or with a flame. A pulsating, in particular a regularly or irregularly pulsating, or a uniformly turbulent hot gas stream can be generated as the hot gas stream.

In a preferred embodiment, the battery material and/or battery precursor material obtained is separated from the hot gas stream at only one separation point. In particular, all solid substances are separated from the hot gas stream at the separation point.

According to the invention, the thermal treatment of the battery material and/or battery precursor material, which in particular contains sodium or lithium, is carried out with a residence time of 0.1 s to 2 s in the reaction space. The residence time determines the duration of the treatment and the desired thermal treatment of the battery material, for example whether it should only be dried or only calcined or both dried and calcined.

A further aspect of the invention provides that the battery material and/or battery precursor material is dried and calcined in a single step in the treatment zone. In other words: the thermal treatment of the battery material and/or battery precursor material as the starting compound and its conversion in the thermal reactor by synthesis and/or drying and calcination takes place in a self-contained system. Such a synthesis and/or drying and calcination process reduced to a single step is particularly environmentally friendly and resource-saving. The synthesis and/or drying and calcination takes place in direct contact with the hot gas stream in a single operation within the thermal reactor. The amount of heat transferred through the direct heat exchange per material unit and thus also the length of the synthesis time and/or drying time and calcination time can be controlled, for example, by the combustion, in particular by the supplied quantity of combustion gas and/or fuel, and/or the material flow, in particular the battery material and/or battery precursor material, in the reaction space of the thermal reactor.

In addition, when the thermal reactor is designed as a pulsation reactor, the thermal treatment is particularly homogeneous and uniform. However, the thermal reactor can also be designed as an entrained flow reactor.

In a further embodiment, the starting compound is introduced into the reaction space by means of a carrier fluid and/or as an aerosol. For example, the carrier fluid is a gas, in particular ambient air or oxygen or an inert gas, such as Nitrogen. The starting compound can be fed into the reactor in the area of the reaction space and/or in the area of a combustion chamber in a directly fired reactor. The choice of the feeding point in the reactor depends on which thermal treatment is to be achieved. In particular, the treatment duration and the effect of temperature are changed by the selection of the feeding point. For example, for drying and calcining the battery material, the same is introduced into the reactor at a front feed point, viewed in the flow direction of the hot gas stream in the reactor, in particular into the combustion chamber and/or the reaction space. To dry the battery material, it is introduced into the reactor at a rear feed point, in particular only into the reaction space, as viewed in the direction of flow of the hot gas stream in the reactor.

The hot gas stream in the reaction chamber preferably pulsates or oscillates regularly or irregularly, in particular with a frequency of between 5 Hz and 350 Hz.

In addition, it can be provided that the battery material, after the thermal treatment in the treatment zone, is transferred to a cooling zone of the reaction space and then removed from the reaction space and deposited in powder form.

The battery material can in particular be a sodium or lithium-containing battery material.

The lithium-containing battery material is in particular a lithium material containing nickel, manganese and/or cobalt, for example LiMn₂O₄, LiCoxMn₂₋ₓO₄ or Li(NiCoMn)O₂ (also called NCM for short), a lithium material containing iron phosphate, for example LiFePO₄ (also called LFP for short), a lithium material containing nickel and manganese, for example LiNiₓMn₂₋ₓO₄ (also called LNMO for short), an iron phosphate and manganese phosphate containing lithium material, for example LiFe₁₋ₓMnₓPO₄ (also called LMP for short), a lithium material containing nickel, cobalt and/or aluminum, for example LiAlO₂ or LiNiCoAlO₂ (also called NCA for short), a cobalt and oxygen-containing lithium material, for example LiCoO₂ (also called LCO for short) or a titanium and oxygen-containing lithium material, for example Li₄Ti₅O₁₂ (also called LTO for short) or a manganese, iron phosphate containing lithium material.

Specifically, the sodium-containing battery material is a nickel-, manganese-, titanium-, and iron-containing sodium material, or an iron phosphate-containing sodium material, a permanganate-containing sodium material, or a chromium-containing sodium material.

The lithium material containing nickel, manganese and cobalt is in particular a lithium parent compound with proportions of nickel, cobalt and manganese. The lithium material containing nickel, cobalt and manganese can have stoichiometric proportions of nickel, cobalt and manganese (1:1:1) or non-stoichiometric proportions (5:3:1, 6:2:2, 8:1:1 (nickel-rich)). Surprisingly, it has been shown that a lithium-containing battery material with a lower proportion of lithium than the proportions of other components of this battery material has advantages in terms of necessary resources and environmental protection. The proportion of lithium is lower in the nickel, cobalt and manganese containing lithium material compared to the proportions of nickel, cobalt and manganese. Also in the other lithium materials with other proportions, such as iron phosphate, aluminum, oxygen, the proportion of lithium is lower compared to these other proportions, such as iron phosphate, aluminum, oxygen.

The nano- and/or micro-scale or nano- and/or micro-crystalline battery material that is obtained and deposited has, in particular, an average particle size in the range from 10 nm to a few micrometers, in particular up to 50 μm.

With the method according to the invention, in particular nanoscale and/or microscale or nanoscale and/or microcrystalline battery materials and/or battery precursor materials can be thermally treated, in particular dried and/or calcined. Such a thermally treated nano- and/or micro-scale or nano- and/or micro-crystalline battery material is particularly suitable for use as a cathode or anode material.

The invention also provides for the use of a thermal reactor with at least one reaction space and at least one heating arrangement and/or an arrangement for generating a hot gas stream, in particular a pulsation arrangement for generating a pulsating hot gas stream, in the reaction space for thermal treatment by synthesis and/or drying and calcination of a nano- and/or micro-scale or nano- and/or micro-crystalline battery material in the reaction space of the thermal reactor. The thermal reactor is set up to carry out the method described above.

Exemplary embodiments of the invention are explained in more detail below with reference to a drawing.

Herein, the only
FIGURE shows a block diagram of a device for producing particles with a reactor.

The only FIGURE shows a block diagram of a device V for the thermal treatment of a nanoscale and/or microscale or nanoscale and/or microcrystalline battery material BM in a reaction space 1.1 of a thermal reactor 1.

For example, the battery material BM in the end product has an average particle or grain size in the range from 10 nm to a few micrometers. A battery material BM means in particular one or more battery materials, a battery material mixture or a preprocessed battery material or a preprocessed battery material mixture or a battery precursor material BM. The battery material BM is a nanoscale and/or microscale or nanocrystalline and/or microcrystalline battery material BM, in particular a sodium or lithium-containing battery material BM.

The device V is designed as a thermal reactor 1. The thermal reactor 1 comprises at least one reaction space 1.1 and at least one feeding point 1.2 for feeding the battery material BM for the thermal treatment of the battery material RM in the reaction space 1.1 and a separation point 1.3 for the output and separation of the thermally treated battery material BM in powder form.

The battery material BM or a battery precursor material in the form of a starting compound AV is introduced at the feeding point(s) 1.2. In particular, the starting compound AV of the battery material BM or the battery precursor material is applied in the form of a solution, slurry, suspension or in a solid state of aggregation of a battery material or battery material mixture or a battery precursor material BM and introduced into the reaction space 1.1.

The thermal reactor 1 can be, for example, an entrained flow reactor, a pulsation reactor, a dryer, a calciner or another suitable system or container for the thermal treatment of the battery material BM and/or the battery precursor material BM in a hot gas stream HGS or in a pulsating hot gas stream HGS.

The thermal reactor 1 as an entrained flow reactor or as a pulsation reactor is characterized by a thermal treatment of the droplets or particles down to powder in a hot, flowing gas or a hot, flowing and pulsating gas, which carries the particles at the same time and thus conveys them through the thermal reactor 1, in particular, depending on the feeding point 1.2, through an application space 2.1 and/or through the reaction space 1.1. In particular, this thermal reactor 1 can be an entrained flow reactor, a pulsation reactor, a dryer, a calciner or another suitable system or container for the thermal treatment of the battery material BM in a hot gas stream HGS, in particular a pulsating or oscillating hot gas stream HGS.

In an entrained flow reactor, the battery material BM and/or the battery precursor material BM is carried by a hot gas stream HGS and guided through the reaction space 1.1 and thermally treated therein.

In the thermal reactor 1, in particular in a treatment zone, for example in the application space 2.1 and/or in the reaction space 1.1, the battery material BM and/or battery precursor material BM carried in the hot gas stream HGS is thermally treated at a temperature of 150° C. to 1,000° C. with a residence time of 0.1 s to 2 s. The starting compound, in particular a battery precursor material, is reacted into the battery material BM by synthesis and/or drying and calcination in a single step in the hot gas stream HGS in the thermal reactor 1. The battery material BM obtained in the process in powder form is then removed from the thermal reactor 1.

Such a synthesis and/or drying and calcination method for the thermal treatment of the battery material BM, which is reduced to a single step, is particularly environmentally friendly and resource-saving. The synthesis and/or drying and calcination takes place in direct contact with the hot gas stream HGS in a single operation within the thermal reactor 1.

The hot gas stream HGS is generated in the thermal reactor 1 by supplying and igniting a fuel BS and a combustion gas VG. The hot gas stream HGS is formed by hot gases produced during the combustion of the fuel BS and the combustion gases VG. The combustion can take place without a flame, for example. Combustion with a flame is also possible. The hot gas stream HGS that is generated can flow in the reactor 1 in a regular or irregular pulsating manner, or it can flow in the reactor 1 in a uniformly turbulent manner.

The thermal reactor 1 is described below using a pulsation reactor and is therefore referred to as a pulsation reactor 1 below.

In the pulsation reactor 1, the battery material BM is thermally treated in a pulsating, oscillating hot gas stream HGS.

For this purpose, the pulsation reactor 1 comprises a generator 2 for generating the pulsating hot gas stream HGS The generator 2 is, for example, a burner with an application space 2.1 adjoining the burner, e.g. a combustion chamber, and/or another technical implementation for heating the hot gas stream HGS in combination with the application space 2.1.

Alternatively or additionally, the pulsation reactor 1 can comprise at least one pulsator (not shown), which is arranged on the reaction space 1.1, which is connected downstream of the application space 2.1. The pulsator can, for example, be coupled to the reaction chamber 1.1 from the outside and impresses at least one pressure oscillation to generate or amplify the pulsating hot gas stream HGS into the reaction space 1.1.

In an alternative or additional embodiment, the hot gas stream HGS can be heated by means of a heat exchanger or electrically and by means of the pulsator instead of the fired generation and heating or in addition to the fired generation and heating.

The pulsating hot gas stream HGS flows from the application space 2.1 into the downstream reaction space 1.1 or through the reaction space 1.1.

When using a burner as a generator 2, combustion gases VG and at least one fuel BS are brought in detail into the burner together or separately via a feed 3 and, via the burner into the combustion chamber.

In particular, a combustible gas, such as natural gas and/or hydrogen, is supplied as the fuel BS. Another suitable gas can also be supplied as fuel gas.

For example, ambient air, oxygen, etc., is used as the combustion gas VG. The supplied combustion gases VG and fuels BS are ignited, for example, in the application space 2.1, in particular in the combustion chamber. The resulting flame pulsates due to a self-excited, periodic, transient combustion in the application space 2.1 and generates the pulsating hot gas stream HGS in the application space 2.1. The pulsating hot gas stream HGS flows from the application space 2.1 on the flow outlet side into the reaction space 1.1. The reaction space 1.1 is designed, for example, as a resonance tube. The reaction space 1.1 can optionally be followed by a further reaction space (not shown). The reaction chamber 1.1 characterizes an area of the pulsation reactor 1 which extends from the feed 3 to at least the end of the reaction chamber 1.1 designed as a resonance tube and in which the battery material BM is thermally treated.

In detail, the fuel BS and the necessary combustion gas VG are fed together (for example premixed in an upstream mixing chamber) or separately via the generator 2, in particular the burner, to the application space 2.1, in particular the combustion chamber, and ignited there. The fuel BS and the combustion gas VG burn very quickly and generate a pressure wave in the direction of the reaction chamber 1.1, for example in the direction of the resonance tube. Due to the lower flow resistance in the direction of the reaction chamber 1.1, a pressure wave propagates. During the course of the acoustic oscillation, the pressure in the application space 2.1, in particular in the combustion chamber, is reduced so that a new fuel gas mixture or new fuel BS and combustion gas VG can flow in. This process of influx due to pressure fluctuations takes place periodically and is self-regulating.

In a further possible embodiment, a reaction gas, such as air and/or nitrogen and/or forming gas, is fed to a heat exchanger. This heat exchanger heats the reaction gas to the desired temperature and then feeds it to the application space 2.1. Likewise, by using one or more pulsators at the reaction space 1.1, a pulsating hot gas stream is created. Here, the composition of the hot gas stream HGS is not tied to a combustion exhaust gas, but can be chosen almost freely. If a reaction is required in the reaction chamber 1.1 under inert conditions, nitrogen, for example, can be used as the reaction gas. The pulsating hot gas stream HGS therefore consists only of nitrogen.

The pulsating hot gas stream HGS is characterized by a high degree of turbulence. The high flow turbulence and the constantly changing flow speed prevent the build-up of an insulating gas envelope (boundary layer) around the solid particles of the battery material BM, which allows for a higher heat transfer and mass transport (between battery material BM and hot gas), i.e. a faster reaction at comparatively lower temperatures. Typically, the residence time is less than a second to a few milliseconds.

To separate the thermally treated battery material BM as an end product in powder form from the hot gas stream HGS, a suitable separator 4 follows the reaction space 1.1. After the thermal treatment in a treatment zone in the reaction space 1.1, the battery material BM is transferred to a cooling zone of the reaction space 1.1 and then removed from the reaction space 1.1 and deposited in powder form in the separating device 4.

The frequency of the pulsating hot gas stream HGS is in the Hertz range, in particular in a range of a few Hertz, for example greater than 5 Hz, in particular greater than 50 Hz, for example in a range from 5 Hz to 350 Hz, in particular from 10 Hz to 150 Hz.

Parameters of the hot gas stream HGS, such as the amplitude and/or frequency of the oscillation, can be set particularly easily using the generator 2 and/or pulsator. In addition, this can be done via the combustion parameters, such as fuel quantity, air quantity, air temperature, fuel temperature and/or flame temperature, location of the fuel/air feed and/or via proportions and/or changes to these from the application space 2.1, in particular the combustion chamber, generator 2, in particular the burner and/or reaction space 1.1.

The reaction chamber 1.1 is designed, for example, as a resonance tube. If a flame burns in the application space 2.1, this is a combustion chamber. The combustion chamber is then designed as a combustion space whose dimensions, in particular its diameter, are greater than the dimensions, in particular the diameter of the reaction space 1.1. Likewise, the dimensions of the application space 2.1 (without a flame), in particular its diameter, are also larger than the reaction space 1.1.

In an area between a flow outlet of the application space 2.1, in particular the combustion chamber, and a flow inlet of the reaction space 1.1, at least one feeding point 1.2 is arranged, at which the battery material BM is fed.

The choice of the feeding point 1.2 into the pulsation reactor 1 depends on which thermal treatment is to be achieved. The choice of the feeding point 1.2 changes, in particular, the duration of treatment and the effect of temperature. For example, for drying and calcining the battery material BM, this battery material BM is introduced at a front feeding point 1.2 into the reactor 1, viewed in the flow direction of the hot gas stream HGS in the reactor 1, in particular into the combustion chamber and/or the application space 2.1. In order to dry the battery material BM, it is introduced into the reactor 1 at a rear feed point viewed in the flow direction of the hot gas stream HGS in the reactor 1, in particular only into the reaction chamber 1.1.

The starting compound AV of the battery material BM is introduced, for example, into the reactor 1 by means of a carrier fluid and/or as an aerosol, for example in atomized form. For example, the carrier fluid is a gas, in particular ambient air, oxygen or nitrogen.

In particular, a battery material BM in the form of a solution, slurry, suspension or in a solid state of aggregation is introduced into the reactor 1 as the starting compound AV and is thermally treated there in a treatment zone by means of the pulsating hot gas stream HGS at a temperature of 150° C. to 1,000° C., in particular dried and/or calcined. Subsequently, the obtained battery material BM is removed from the reactor 1 in powder form.

In a preferred embodiment, the battery material BM obtained is separated from the hot gas stream HGS at only one separation point 1.3. In particular, all solid substances are separated from the hot gas stream HGS at the separation point 1.3. The separation point 1.3 can be designed, for example, as a filter or centrifugal separator.

One embodiment provides that the thermal treatment of the battery material BM is carried out in the reactor 1 with a residence time of 0.1 s to 2 s. The residence time determines the duration of the treatment and the desired thermal treatment of the battery material BM, whether this is to be only dried or only calcined, or both dried and calcined, for example.

Surprisingly, it turned out that the battery material BM can be dried and calcined in a single step in the treatment zone of the reactor 1. Such a drying and calcination process, reduced to a single step, is particularly environmentally friendly and resource-saving.

The battery material BM is in particular a lithium material containing nickel, manganese and/or cobalt, for example LiMn₂O₄, LiCoₓMn₂₋ₓO₄ or Li(NiCoMn)O₂ (also called NCM for short), a lithium material containing iron phosphate, for example LiFePO₄ (also called LFP for short), a lithium material containing nickel and manganese, for example LiNiₓMn₂₋ₓO₄ (also called LNMO for short), an iron and manganese containing lithium material, for example LiFe₁₋ₓMnₓPO₄ (also called LMP for short), a lithium material containing nickel, cobalt and/or aluminum, for example LiAlO₂ or LiNiCoAlO₂ (also called NCA for short), a cobalt and oxygen-containing lithium material, for example LiCoO₂ (also called LCO for short) or a titanium and oxygen-containing lithium material, for example Li₄Ti₅O₁₂ (also called LTO for short) or a nickel, manganese, titanium and iron containing sodium material or a manganese, iron phosphate containing lithium material.

The lithium material containing nickel, manganese and cobalt is in particular a lithium parent compound with proportions of nickel, cobalt and manganese. The lithium material containing nickel, cobalt and manganese can have stoichiometric proportions of nickel, cobalt and manganese (1:1:1) or non-stoichiometric proportions (5:3:1, 6:2:2, 8:1:1 (nickel-rich)). The proportion of lithium is lower in the nickel, cobalt and manganese containing lithium material compared to the proportions of nickel, cobalt and manganese.

The nano- and/or micro-scale or nano- and/or micro-crystalline battery material that is obtained and deposited has, in particular, an average particle size in the range from 10 nm to a few micrometers, in particular up to 50 μm.

Examples of powders based on battery material BM containing sodium or lithium can be used to show that particularly fine-grain powders can be thermally treated and produced in a single step in the hot gas stream HGS in the thermal reactor 1 by combining the inventive measures.

### EXAMPLE 1

### Thermal Treatment and Preparation of a Compound LiFePO₄ (LFP) as an Example of a Lithium-Containing Battery Material

A metal phosphate powder with the composition LiFePO₄ was produced as a lithium-containing battery material BM. For this purpose, an aqueous solution of iron(III) nitrate nonahydrate, lithium hydroxide monohydrate and phosphoric acid in the respective stoichiometric ratio and a total product concentration of 15% by weight (calculated as LiFePO₄) was reacted into lithium iron phosphate in the hot gas stream HGS in the pulsation reactor 1. The aqueous solution (starting compound AV) was introduced into the combustion chamber (application space 2.1) at a rate of 3 kg/h using a two-component nozzle and thermally treated at a temperature of 650° C. in the pulsation reactor 1, in particular reacted in a single step and thus synthesized, dried and calcined in a single step in thermal reactor 1. The product (battery material BM in powder form) was separated from the cooled gas stream by a filter (separator 4).

The resulting brown powder had a specific surface area (BET) of 2 m²/g and a loss on ignition of 0.6% by weight. The X-ray diffraction analysis showed an amorphous background with reflections of a lithium iron phosphate phase. Chemical analysis (ICP-OES) gave 34 wt % iron (theoretical 35.4 wt %), 4.3 wt % lithium (theoretical 4.4 wt %) and 18.9 wt % phosphorus (theoretical 19.63 wt. %). The product stoichiometry corresponds to the composition set in the educt solution.

### EXAMPLE 2

### Thermal Treatment and Preparation of a Compound LiMn_{0.5}Fe_{0.5}PO₄ (LMFP) as an Example of a Lithium-Containing Battery Material

A metal phosphate powder with the composition LiMn_{0.5}Fe_{0.5}PO₄ was produced as lithium-containing battery material BM. For this purpose, an aqueous solution of iron (III) nitrate nonahydrate, lithium hydroxide monohydrate, manganese (II) acetate tetrahydrate and phosphoric acid in the respective stoichiometric ratio and a total product concentration of 15% by weight (calculated as LiMn_{0.5}Fe_{0.5}PO₄) was reacted in the hot gas stream HGS in the pulsation reactor 1. The aqueous solution (starting compound AV) was introduced into the combustion chamber (application space 2.1) at 3 kg/h using a two-component nozzle and reacted at a temperature of 500° C. in the hot gas stream HGS in the pulsation reactor 1 in a single step and thus synthesized, dried and calcined in the thermal reactor 1 in a single step. The product (battery material BM in powder form) was separated from the cooled gas stream by a filter (separator 4).

The resulting brown powder had a specific surface area (BET) of 14 m²/g and a loss on ignition of 2.2% by weight. The X-ray diffraction analysis showed an amorphous background with reflections of a lithium iron phosphate and lithium manganese iron phosphate phase. Chemical analysis (ICP-OES) gave 19.9% by weight iron (theoretical 17.75% by weight), 4.3% by weight lithium (theoretical 4.41% by weight), 15.3% by weight manganese (theoretical 17.46 wt %) and 19.3 wt % phosphorus (theoretical 19.69 wt %). The product stoichiometry corresponds approximately to the composition set in the educt solution.

### EXAMPLE 3

### Thermal Treatment and Preparation of a Compound Na_{0.67}Mn_{0.5}Fe_{0.5}O₂ as an Example of a Battery Material Containing Sodium

A metal oxide powder with the composition Na_{0.67}Mn_{0.5}Fe_{0.5}O₂ was produced as the sodium-containing battery material BM. For this purpose, an aqueous solution of iron(III) nitrate nonahydrate, sodium carbonate and manganese(II) acetate tetrahydrate in the respective stoichiometric ratio and a total product concentration of 15% by weight (calculated as Na_{0.67}Mn_{0.5}Fe_{0.5}O₂) was reacted in the hot gas stream HGS in the pulsation reactor 1. The aqueous solution (starting compound AV) was introduced into the combustion chamber (application space 2.1) at a rate of 3 kg/h using a two-component nozzle and treated thermally at a temperature of 800° C. in the pulsation reactor 1, in particular reacted in a single step and thus synthesized, dried and calcined in a single step in the thermal reactor 1. The product (battery material BM in powder form) was separated from the cooled gas stream by a filter (separator 4).

The resulting grey-black powder had a specific surface area (BET) of 9 m²/g and a loss on ignition of 6.2% by weight. The X-ray diffraction analysis showed an amorphous background with reflections of a sodium-manganese-iron oxide and sodium-manganese oxide phase. Chemical analysis (ICP-OES) gave 25.8% by weight iron (theoretical 27.16% by weight), 14.1% by weight sodium (theoretical 14.98% by weight) and 25.8% by weight manganese (theoretical 26.72% by weight). The product stoichiometry corresponds to the composition set in the educt solution.

### LIST OF REFERENCES

1 reactor, pulsation reactor
1.1 reaction space
1.2 feeding point
1.3 separation point
2 generator
2.1 application space
3 feed
4 separating device
AV starting compound
BM battery material/battery precursor material
BS fuel
HGS hot gas stream
VG combustion gas

1. A method for thermal treatment of at least one of a battery material and a battery precursor material which is at least one of nano-scale, micro-scale, nano-crystalline and micro-crystalline, the thermal treatment being performed in a thermal reactor having an application space and a reaction space, the method comprising the steps:
introduction of a starting compound at a front feed point into the thermal reactor, seen in the direction of flow of a hot gas stream flowing in the thermal reactor, wherein the starting compound being at least one of a battery material and a battery precursor material is introduced into the reactor in the form of one of a solution, slurry, suspension and a solid state of aggregation,
thermal treatment of the at least one of the battery material and battery precursor material (BM) carried in the hot gas stream in a treatment zone in the thermal reactor at a temperature of 150° C. to 1,000° C. with a residence time of 0.1 s to 2 s, the starting compound being reacted into the battery material by at least one of synthesis and combination of drying and calcination in a single step in the hot gas stream in the thermal reactor, and
discharging the obtained battery material in powder form from the reactor.

2. The method according to claim 1, wherein, if the starting compound is a battery precursor material, the reaction to the battery material takes place by synthesis, drying and calcination in a single step in the hot gas stream of the thermal reactor.

3. The method according to claim 1, wherein, if the starting compound is a moist battery material, the reaction to the battery material takes place by drying and calcining in a single step in the hot gas stream of the thermal reactor.

4. The method according to claim 1, wherein the starting compound is introduced into the reactor by means of a carrier fluid.

5. The method according to claim 1, wherein the hot gas stream pulsates one of regularly and irregularly.

6. The method according to claim 1, wherein after the thermal treatment in the treatment zone, the battery material is transferred to a cooling zone of the reactor and then removed from the reactor and deposited in powder form.

7. The method according to claim 1, wherein the battery material is one of a lithium-containing and a sodium-containing battery material.

8. The method according to claim 7, wherein the lithium-containing battery material is one of a lithium material containing nickel, manganese and cobalt, an iron phosphate-containing lithium material, a lithium material containing nickel and manganese, a lithium material containing iron and manganese, a lithium material containing nickel, cobalt and aluminum, a cobalt- and oxygen-containing lithium material, a titanium and oxygen-containing lithium material, and a manganese, iron phosphate-containing lithium material.

9. The method according to claim 7, wherein the sodium-containing battery material is one of a nickel, manganese, titanium and iron-containing sodium material, an iron phosphate containing sodium material, a permanganate containing sodium material, and a chromium containing sodium material.

10. A battery material being at least one of nano-scale, micro-scale, nano-crystalline, and micro-crystalline, wherein the battery material is obtainable by a method according to claim 1.

11. The battery material according to claim 10, having an average particle size in the range from 10 nm to a few micrometers.

12. A use of the battery material according to claim 10 as a battery material.

13. A use of a thermal reactor with at least one reaction space and at least one generator for generating a hot gas stream for carrying out the method according to claim.

14. The method according to claim 1, wherein the starting compound is introduced into the reactor as an aerosol.

15. The method according to claim 5, wherein the hot gas stream pulsates with a frequency of between 5 Hz and 350 Hz.

16. The battery material according to claim 11, having an average particle size of up to 50 μm.

17. The use according to claim 12, wherein the battery material is used as one of a cathode material and an anode material.
